(19) United States
(12) Patent Application Publication
(10) Pub. No.: US 2019/0162519 A1
(43) Pub. Date: May 30, 2019

(54) PHOTODETECTOR

(71) Applicant: Rain Tree Photonics Pte. Ltd., Singapore (SG)

(72) Inventors: Ying Huang, Singapore (SG); Tsung-Yang Liow, Singapore (SG)

(73) Assignee: Rain Tree Photonics Pte. Ltd., Singapore (SG)

(21) Appl. No.: 16/206,305

(22) Filed: Nov. 30, 2018

Related U.S. Application Data
(60) Provisional application No. 62/592,426, filed on Nov. 30, 2017.

(51) Int. Cl. G01B 9/02; G02B 6/28; G02B 6/27

(52) U.S. Cl. CPC G01B 9/02018; G02B 6/27; G02B 6/2813

(57) ABSTRACT

A photodetector (10) is provided. The photodetector (10) includes an interferometer (12) and a photodetection region (14) coupled to the interferometer (12). The interferometer (12) is configured to generate an optical intensity distribution that corresponds to an electric field distribution in the photodetection region (14).

### FIELD OF THE INVENTION

The present invention relates to the field of photonics and more particularly to a photodetector.

### BACKGROUND OF THE INVENTION

Photodetectors convert optical signals into electrical signals and are typically used in receivers. To increase sensitivity of a receiver, it would be desirable to provide a photodetector with high responsivity, high speed (bandwidth) and low dark leakage current.

### SUMMARY OF THE INVENTION

Accordingly, in a first aspect, the present invention provides a photodetector including an interferometer and a photodetection region coupled to the interferometer. The interferometer is configured to generate an optical intensity distribution that corresponds to an electric field distribution in the photodetection region.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1A is schematic top plan view of a photodetector in accordance with an embodiment of the present invention;

FIG. 1B is a schematic cross-sectional view of the photodetector taken along line A-A in FIG. 1A;

FIG. 1C is a schematic cross-sectional view of the photodetector taken along line B-B in FIG. 1A;

FIG. 2 is a schematic cross-sectional view of a photodetector in accordance with yet another embodiment of the present invention;

FIG. 3 is a schematic top plan view of a photodetector in accordance with still another embodiment of the present invention;

FIG. 4 is a schematic cross-sectional view of a photodetection region of a photodetector in accordance with another embodiment of the present invention;

FIG. 5 is a schematic top plan view of a photodetector in accordance with yet another embodiment of the present invention;

FIG. 6 is schematic top plan view of a photodetector in accordance with still another embodiment of the present invention; and

FIG. 7 is schematic top plan view of a photodetector in accordance with another embodiment of the present invention.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

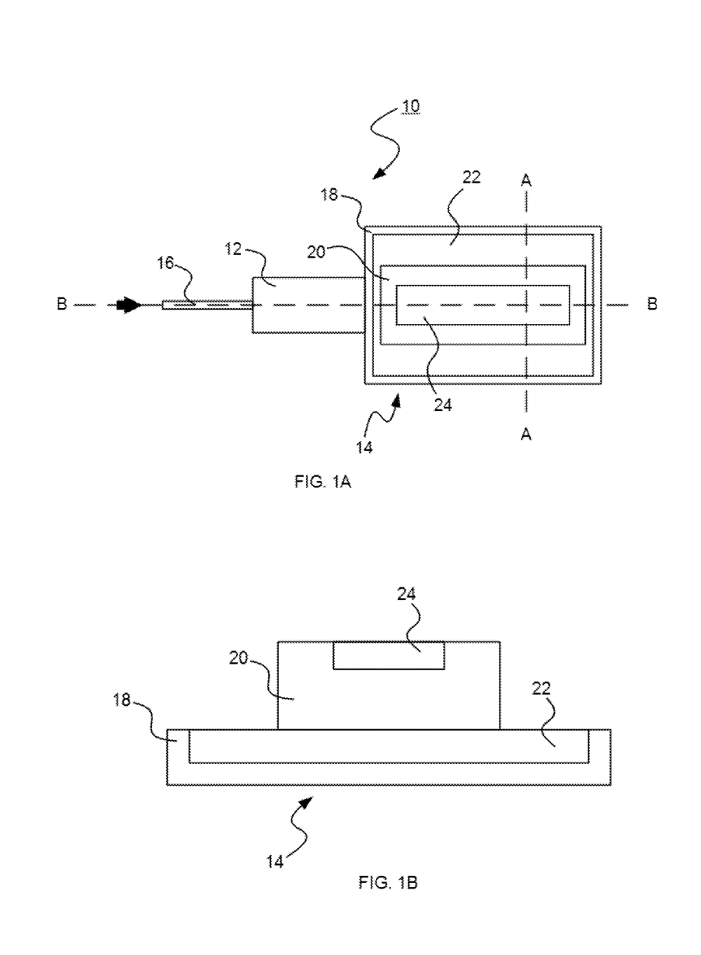

Referring now to FIGS. 1A through 1C, a photodetector 10 is shown. The photodetector 10 includes an interferometer 12 and a photodetection region 14 coupled to the interferometer 12.

In the embodiment shown, the photodetector 10 includes a waveguide 16 and 5 the interferometer 12 is coupled between the waveguide 16 and the photodetection region 14. Light is guided into the photodetector 10 from waveguide 16. In this manner, the waveguide 16 serves as an incoming waveguide and may be a single-mode waveguide.

In the present embodiment, the photodetection region 14 includes a substrate 18 and an absorption region 20 provided on the substrate 18, the substrate 18 and the absorption region 20 having opposite polarities. The substrate 18 may be formed of silicon (Si) and the absorption region 20 may be provided on the substrate 18 by growing an absorption layer comprising a material such as germanium (Ge) on the silicon substrate 18. This enables absorption of light in the near-infrared wavelength range. One or both the substrate 18 and the absorption region 20 may be formed as a mesa. A first contact region 22 and a second contact region 24 of the photodetection region 14 may be formed by doping the the substrate 18 and the absorption region 20 to form a p-type doping region and an n-type doping region. The first and second contact regions 22 and 24 may be connected to metal electrodes (not shown).

The interferometer 12 is configured to generate an optical intensity distribution that corresponds to an electric field distribution in the photodetection region 14. The interferometer 12 may be a multi-mode interferometric waveguide. Before reaching the photodetection region 14, light first passes through the multi-mode interferometer 12. This excites multiple optical modes, resulting in a pre-determined distribution of regions 25 with high and low optical power intensities within the multi-mode interferometer 12 and in the photodetection region 14. The multi-mode interferometric waveguide may be designed such that regions of high optical intensity occur only at specific regions within the absorption region 20 where the electric field is sufficiently strong so as to maximize the transit-time-limited bandwidth of the photodetector 10. Advantageously, by maintaining a high enough electric field in regions with high optical intensity, transit-time-limited bandwidth is increased. The local electric field intensity within the absorption mesa 20 may also be engineered for optimum performance.

In an embodiment where the absorption region 20 is formed of germanium (Ge), the doped region 24 may be set at a distance from a perimeter of the absorption region 20. In germanium photodetectors, due to the small bandgap of germanium and the high density of surface states, a distance may be left from the edge of the doping region 24 to the edge of the absorption mesa 20 around the perimeter of the absorption mesa 20 to reduce the dark leakage current of the photodetector 10.

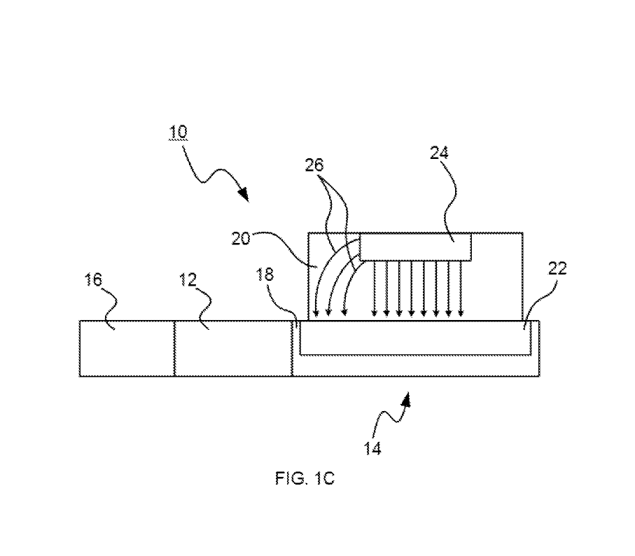

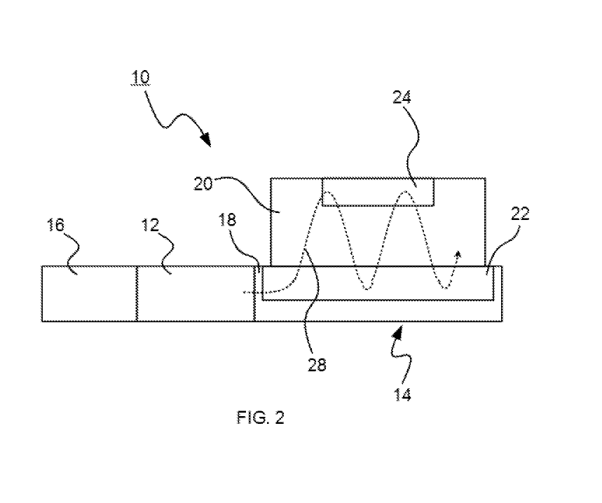

Referring now to FIG. 1C, electric field lines 26 illustrating weaker electric field intensities near the perimeter of the absorption mesa 20 are shown. The electric field nearer to the edge of the absorption mesa 20 is weaker compared to the electric field in the centre of the absorption mesa 20 because of the distance from the edge of the doping region 24 to the edge of the absorption mesa 20. To reduce or minimise degradation of the high-speed performance of the photodetector 10 as carriers in these regions have longer carrier transit times, the interferometer 12 may be designed to reduce the optical intensity in these regions of low electric field as shown in FIGS. 2 and 3.

Referring now to FIG. 2, an optical mode propagation characteristic 28 of the interferometer 12 designed to avoid regions in the absorption mesa 20 with low electrical field intensity is shown.

Referring now to FIG. 3, the photodetector 10 with regions 30 of high optical intensity superimposed is shown.

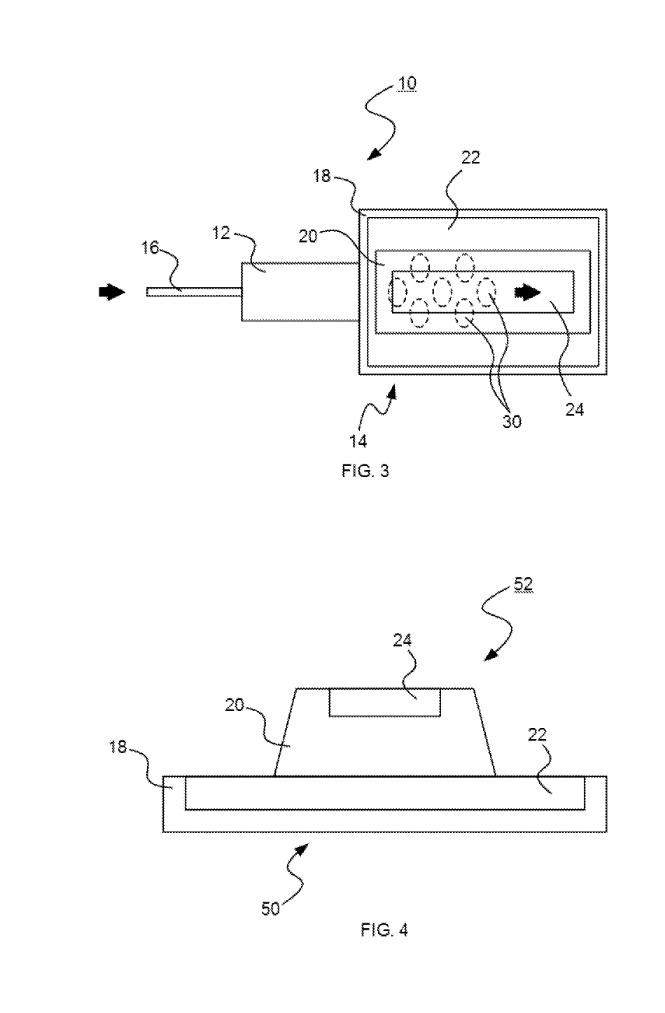

Referring now to FIG. 4, a photodetection region 50 of a photodetector 52 in accordance with another embodiment of the present invention is shown. The photodetector 52 of the present embodiment differs from the earlier embodiments in that the sidewall profile of the absorption mesa 20 is not vertical. In alternative embodiments, the sidewall profile of the absorption mesa 20 may be of other shapes.

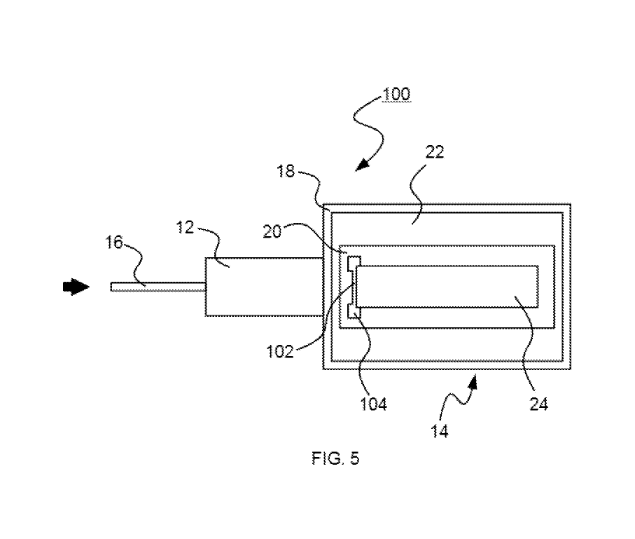

Referring now to FIG. 5, a photodetector 100 in accordance with yet another embodiment of the present invention is shown. The photodetector 100 of the present embodiment differs from the earlier embodiments in that a structure 102 is provided with the doped region 24 at a starting portion of the absorption region 20. In the present embodiment, the structure 102 includes serif-like protruding portions 104. The serif-like structures 102 may be added to the top contact region 24 at the start of the absorption mesa 20 to increase the local electric field intensity in the critical absorption mesa regions where the optical intensity is the highest. This has the benefit of improving the overall high-speed performance of the photodetector 100 while incurring only a small trade-off in dark leakage current performance.

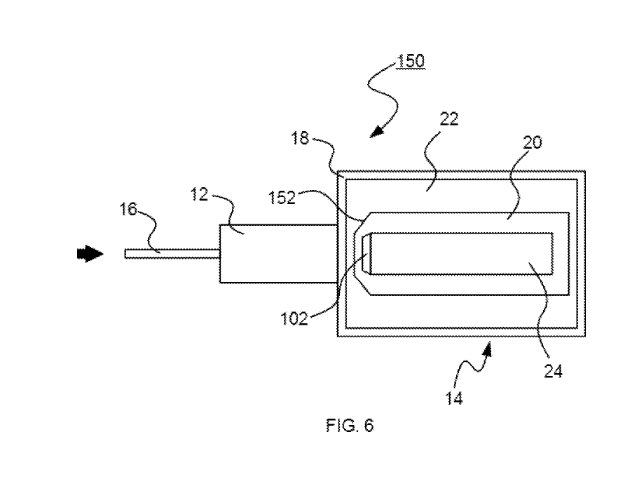

Referring now to FIG. 6, a photodetector 150 in accordance with still another embodiment of the present invention is shown. The photodetector 150 of the present embodiment differs from the earlier embodiments in that corners at a starting portion of the absorption region 20 are chamfered. FIG. 6 also shows a structure 102 of another shape added to the top contact region 24.

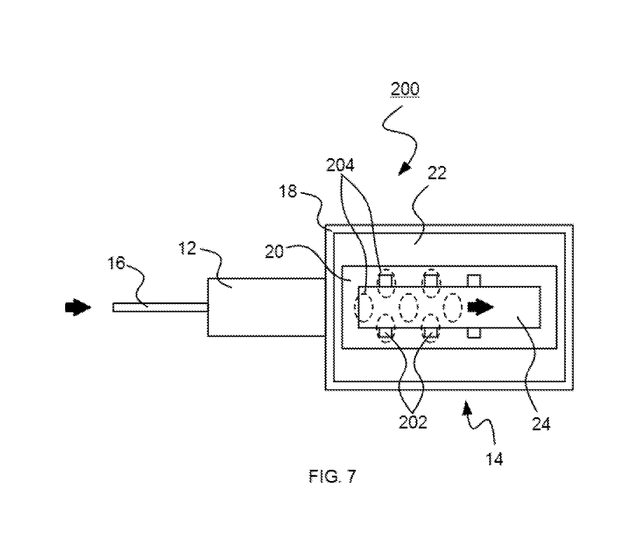

Referring now to FIG. 7, a photodetector 200 in accordance with another embodiment of the present invention is shown. The photodetector 200 of the present embodiment differs from the earlier embodiments in that a plurality of protrusions 202 is provided on the absorption region 20 in a distribution corresponding to the optical intensity distribution in the photodetection region 14. As light propagates down the photodetector 200, there will be regions of high and low optical intensity in the absorption mesa 20. The additional structures 202 in the form of protrusions are added to the top contact region 20 to coincide with regions 204 of high optical intensity. This creates local regions of higher electric fields along the photodetector 200 to achieve high-speed performance whilst minimising dark leakage current.

While preferred embodiments of the invention have been illustrated and described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A photodetector, comprising:
an interferometer; and
a photodetection region coupled to the interferometer, wherein the interferometer is configured to generate an optical intensity distribution that corresponds to an electric field distribution in the photodetection region.

2. The photodetector of claim 1, wherein the interferometer is a multi-mode interferometric waveguide.

3. The photodetector of claim 1, further comprising a waveguide, wherein the interferometer is coupled between the waveguide and the photodetection region.

4. The photodetector of claim 3, wherein the waveguide is a single-mode waveguide.

5. The photodetector of claim 1, wherein the photodetection region comprises a substrate and an absorption region provided on the substrate, the substrate and the absorption region having opposite polarities.

6. The photodetector of claim 5, wherein the absorption region is formed of germanium (Ge) and comprises a doped region set at a distance from a perimeter of the absorption region.

7. The photodetector of claim 6, further comprising a structure provided with the doped region at a starting portion of the absorption region.

8. The photodetector of claim 7, wherein the structure comprises one or more protruding portions.

9. The photodetector of claim 5, where one or more corners at a starting portion of the absorption region are chamfered.

10. The photodetector of claim 5, further comprising a plurality of protrusions on the absorption region in a distribution corresponding to the optical intensity distribution in the photodetection region.
